(19) United States
(12) Patent Application Publication
(10) Pub. No.: US 2022/0034528 A1
(43) Pub. Date: Feb. 3, 2022

(54) Air Purifying Vent System

(71) Applicant: Rohan Christopher Orlando Grant, Ajax (CA)

(72) Inventor: Rohan Christopher Orlando Grant, Ajax (CA)

(21) Appl. No.: 16/945,902

(22) Filed: Aug. 2, 2020

(51) Int. Cl. F24F 3/16; B01D 46/44; B01D 46/42; B01D 47/02; B01D 50/00

(52) U.S. Cl. CPC F24F 3/1603; B01D 46/448; F24F 2003/1614; B01D 47/02; B01D 50/006; B01D 46/4245

(57) ABSTRACT

A filter system includes a liquid filter unit, a HEPA filter unit and an air vent cover. The filter system is installed into an in-room air vent and purifies air received from a forced air system prior to its entrance into a room via the in-room air vent. In some embodiments, the filter system further includes a means for controlling a temperature of the air such that users are able to independently control air temperature in each room of a building.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of air purifiers of existing art and more specifically relates to air purifying vents for forced air systems.

### RELATED ART

A forced air system utilizes ductwork and in-room vents to supply temperature-controlled air to a building. Proper air filtration is important for forced air systems to provide good air quality for occupants of the building as well as increase the efficiency of the forced air system. Air filters may be used in forced air systems. These filters can block airborne particulates including animal dander, pollen, mold spores, and pathogens such as bacteria and viruses. However, these filters are typically installed into a main unit of the forced air system, and as such, each individual room of the building receives an equal level of filtration. This is a problem as different rooms of the building may need different levels of filtration. For example, a room that is frequently occupied by a person with seasonal allergies needs a higher level of filtration than a room that is barely occupied.

Further, forced air systems typically include a main thermostat which controls a temperature of the whole building. Each room of the building is maintained at a temperature according to a sensed temperature of the room in which the main thermostat is located. This causes problems as different rooms of the building may require different temperatures. For example, a room that receives sunlight most of the day will naturally be warmer than other rooms of the building, and as such, needs to be cooler than others. Thus, a suitable solution is desired.

### SUMMARY OF THE INVENTION

In view of the foregoing disadvantages inherent in the known air purifier art, the present disclosure provides a novel air purifying vent system. The general purpose of the present disclosure, which will be described subsequently in greater detail, is to provide a system including at least one filter means and a vent cover for fastening to an in-room vent to filter air prior to entry into the room from the in-room vent.

A filter system is disclosed herein. The filter system may be used for purifying air from a forced air system of a building; the forced air system utilizing ductwork installed within the building configured to deliver moving airflow from the forced air system to at least one room of the building via an in-room air vent. The filter system may be configured for installation to the in-room air vent. The filter system may include a first filter unit including a first air inlet, a liquid receptacle and a first filtered air outlet. The liquid receptacle may be configured to store a liquid therein. The first filter unit may be configured to receive moving airflow via the first air inlet and filter the moving airflow via the liquid before it passes through the first filtered air outlet as once-filtered air.

Further, a second filter unit may be connected to the first filter unit. The second filter unit may include a second air inlet, a filtering means, and a second filtered air outlet. The second filter unit may be configured to receive the once-filtered air and filter the once-filtered air via the filtering means before it passes through the second filtered air outlet as twice-filtered air.

An air vent cover may be provided and configured to fasten over the in-room air vent. The air vent cover may include a plurality of shutters that are selectively able to be opened and closed to control flow of the twice-filtered air into the at least one room.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an air purifying vent system, constructed and operative according to the teachings of the present disclosure.

FIG. 1 is a front view of the filter system during an ‘in-use’ condition, according to an embodiment of the disclosure.

FIG. 2A is a front view of the filter system of FIG. 1, according to an embodiment of the present disclosure.

FIG. 2B is a top front view of the filter system of FIG. 1, according to an embodiment of the present disclosure.

FIG. 2C is a top front view of the filter system of FIG. 1, according to an embodiment of the present disclosure.

FIG. 3A is a front view of the filter system of FIG. 1, according to an embodiment of the present disclosure.

FIG. 3B is a top view of the filter system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to air purifying means and more particularly to an air purifying vent system. The air purifying vent system is used to improve air quality in at least one room by providing a system that fastens to an in-room vent and filters air received from a forced air system prior to its entry into the at least one room. The air purifying vent system may further include a means of adjusting air temperature in each individual room.

Generally, disclosed is a filter system configured to replace conventional vents used in forced air systems. The filter system may include a liquid filter unit having a housing, a basin configured to store a liquid, a first air inlet and a first air outlet. The basin may be removable from the filter system to allow a user to replace the liquid therein. The first air inlet receives air from the forced air system. Further, a fan may be provided to swirl the liquid.

The liquid filter unit may include a temperature regulator rod with a thermostat sensor which may be configured to detect a temperature of air being received from the forced air system. Further, the temperature regulator rod may include a water level sensor configured to sense a level of the liquid in the basin. The filter system may further include a HEPA filter connected to the liquid filter unit. The HEPA filter may be removable from the vent system to allow the user to clean or replace the HEPA filter when substantially soiled.

A vent cover may be attached to the filter system and configured for placement over the in-room vent. Once filtered by the liquid filter unit and the HEPA filter, the air may be dispersed through the vent cover. The vent cover may include a plurality of shutters able to be selectively opened or closed to allow the user to control airflow into the at least one room. The vent cover may include a slider for allowing easy mobility of the plurality of shutters.

A thermostat control box may be attached to the vent cover and configured to control the temperature in each individual room. Further, a rechargeable battery may be included on the vent cover and configured to provide power to the thermostat control box, and in some embodiments, the temperature regulator rod.

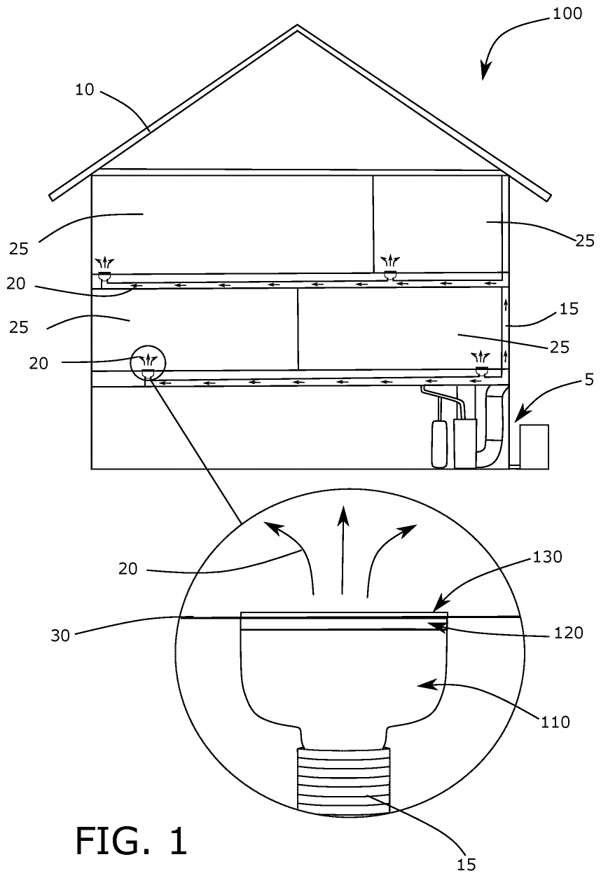

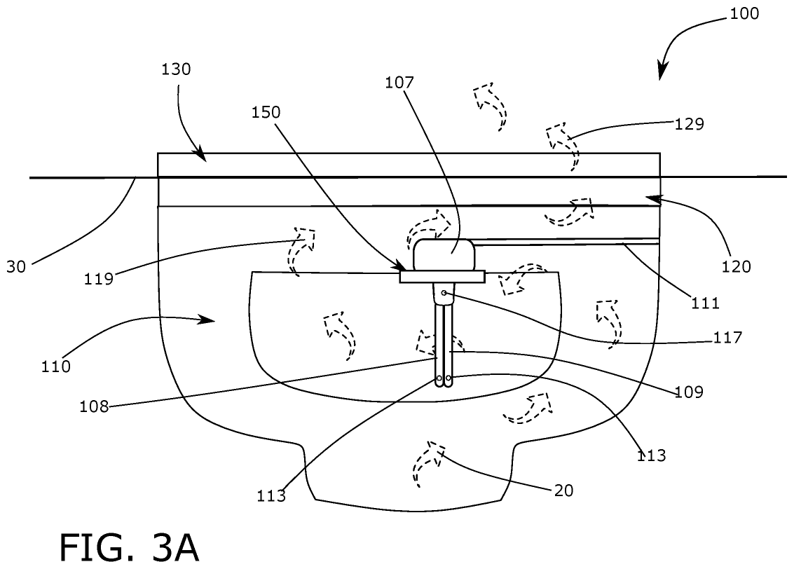

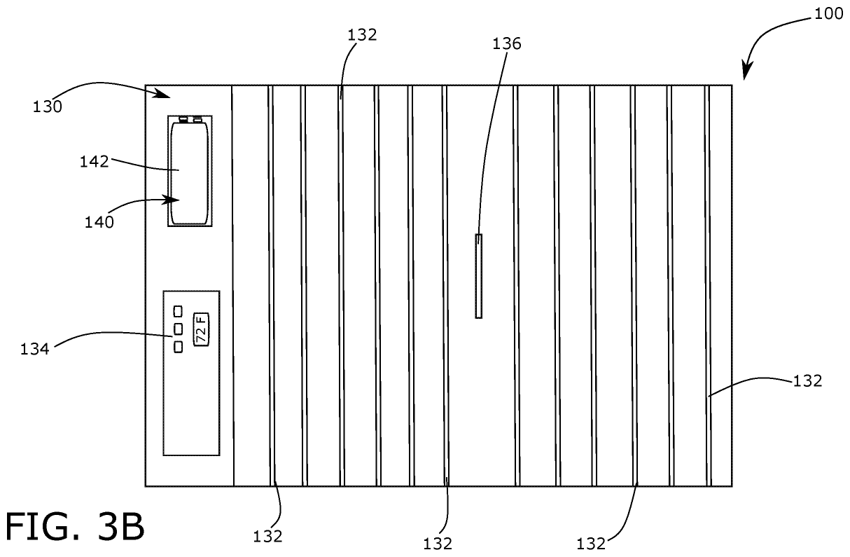

Referring now more specifically to the drawings by numerals of reference, there is shown in FIGS. 1-3B, various views of a filter system 100.

FIG. 1 shows a filter system 100 during an ‘in-use’ condition, according to an embodiment of the disclosure. The filter system 100 may be configured for purifying air from a forced air system 5 of a building 10. The forced air system 5 utilizes ductwork 15 installed within the building 10 configured to deliver moving airflow 20 from the forced air system 5 to at least one room 25 of the building 10 via an in-room air vent 30. The filter system 100 may be configured for installation to the in-room air vent 30. As shown here, the in-room air vent may be a floor-vent. However, the filter system 100 is not limited to being installed into floor-vents. For example, the filter system 100 may be installed into ceiling vents, wall vents, etc. As illustrated, the filter system 100 may include a first filter unit 110, a second filter unit 120 and an air vent cover 130.

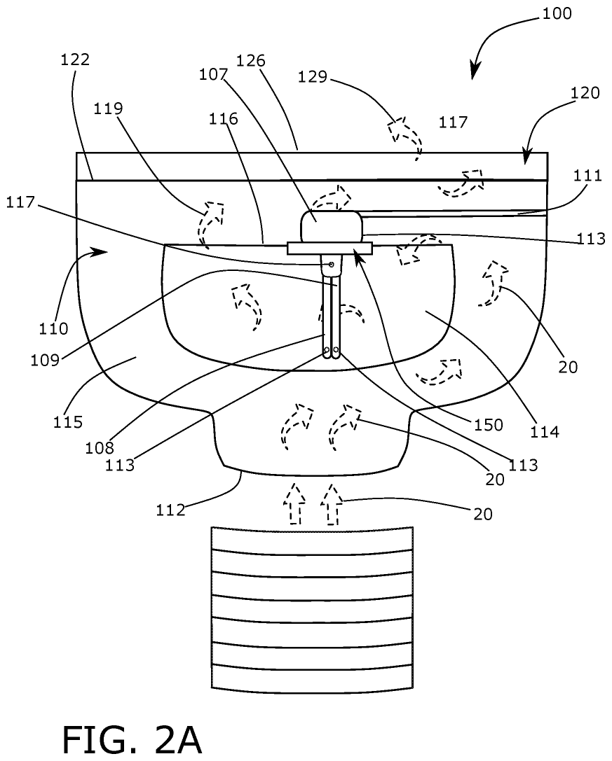

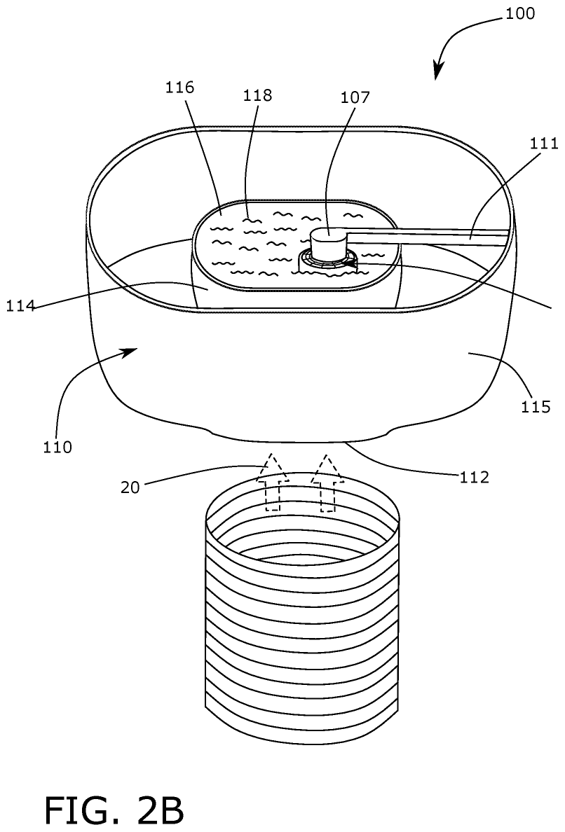

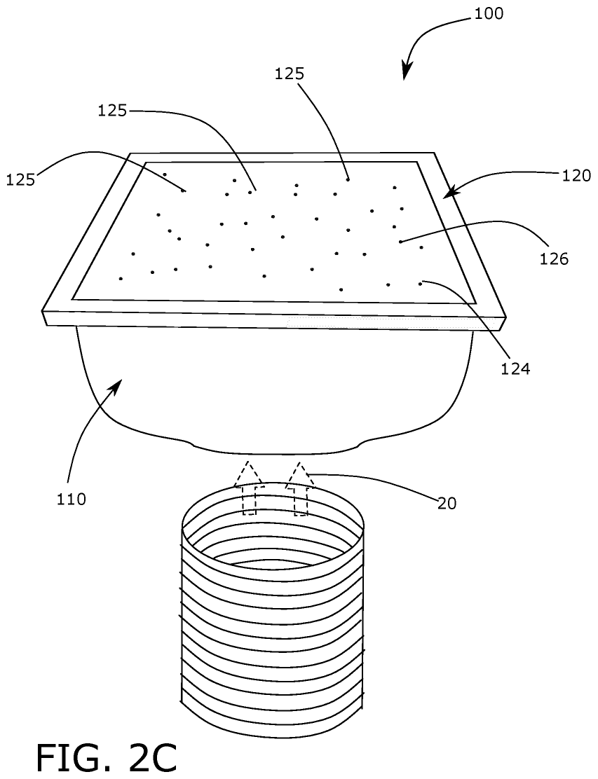

Referring now to FIGS. 2A-2C showing various views of the filter system 100 of FIG. 1, according to an embodiment of the present disclosure. The first filter unit 110 may include a first air inlet 112, a liquid receptacle 114, a receptacle-housing 115 configured to house the liquid receptacle 114, and a first filtered air outlet 116. The liquid receptacle 114 may be configured to store a liquid 118 therein. The first filter unit 110 may be configured to receive moving airflow 20 via the first air inlet 112 and filter the moving airflow 20 via the liquid 118 before it passes through the first filtered air outlet 116 as once-filtered air 119. Preferably, the liquid receptacle 114 may be removable from the filter system 100 to allow a user to empty the liquid 118 and refill with clean liquid 118.

As shown, the filter system 100 may include a temperature-regulator means 111 attached about the liquid receptacle 114. Preferably, the temperature regulator-means 111 may be at least one rod. As shown, in some embodiments, the temperature regulator-means 111 may include two rods comprising a “hot” rod 108 and a “cold” rod 109. Further, a distal tip of the “hot” rod 108 and the “cold” rod 109 may extend to 1 inch above a bottom of the liquid receptacle 114. The “hot” rod 108 may be configured to heat the liquid 118 in the liquid receptacle 114, and the “cold” rod 109 may be configured to cool the liquid 118 in the liquid receptacle 114. The temperature-regulator means 111 may include a temperature-sensor 113 disposed therein and configured to sense a temperature of the moving airflow 20 as it passes through the liquid 118. Other sensing means may be used. Further, the temperature regulator-means 111 may include a water-level sensor 117 configured to sense a level of the liquid 118 in the liquid receptacle 114. In some embodiments, the water-level sensor 117 may alert the user when the level becomes too low and needs to be refilled. The alert may be a visual alert or an audible alarm.

In some embodiments, the filter system 100 may further include a liquid swirling-means 150 attached about the liquid receptacle 114 and configured to swirl the liquid 118 in the liquid receptacle 114. Preferably, the liquid swirling-means 150 may be a fan or other suitable means. The fan may be powered by a motor 107. The fan may be communicably coupled to the temperature-regulator means 111 and attached about the liquid receptacle 114. To facilitate communication, a controller (not illustrated) may be included in the filter system 100. The controller may include a processor and a memory for storing computer executable instructions. Once the temperature-regulator means 111 senses the moving airflow 20, the processor may actuate the fan to begin swirling the liquid 118 in the liquid receptacle 114. The moving airflow 20 may then mix with swirling liquid in the liquid receptacle 114, and filter the moving airflow 20 to be released as once-filtered air 119.

The second filter unit 120 may be connected to the first filter unit 110. The second filter unit 120 may be physically connected to the first filter unit 110 or communicably connected in that once-filtered air 119 is directed into the second filter unit 120.

As shown, the second filter unit 120 may include a second air inlet 122, a filtering means 124, and a second filtered air outlet 126. The second filter unit 120 may be configured to receive the once-filtered air 119 and filter the once-filtered air 119 via the filtering means 124 before it passes through the second filtered air outlet 126 as twice-filtered air 129. Preferably, the second filter unit 120 may be a high-efficiency particulate air (HEPA) filter, however, other filters are contemplated. In some embodiments, the filtering means 124 may include a plurality of fibers 125. The second filter unit 120 may be removable from the filter system. This may allow the user to clean or replace the second filter unit 120.

The filter system 100 may be configured to purify air from the forced air system 5 even if one of the first filter unit 110 or the second filter unit 120 is removed. For example, the second filter unit 120 may be removed from the filter system 100 and the first filter unit 110 may filter the moving airflow 20. Likewise, the first filter unit 110 may be removed from the filter system 100 and the second filter unit 120 may filter the moving airflow 20.

The air vent cover 130 may be configured to fasten over the in-room air vent 30. Once filtered, the moving airflow 20 received from either the first filter unit 110 (as once-filtered air 119) or the second filter unit 120 (as either once-filtered air 119 or twice-filtered air 129 depending on whether the first filter unit 110 is also attached to the filter system 100) may then pass through the air vent cover 130 into the at least one room 25.

In some embodiments, filter system 100 may further include a thermostat control-unit 134 attached to the air vent cover 130. The thermostat control-unit 134 may be set at a desired temperature, enabling the user to independently control temperature of each room. The thermostat control-unit 134 may include selectable modes such as “on”; “hot/cold manual control”; “auto”, etc. As above, the filter system 100 may include the temperature-regulator means 111 attached about the liquid receptacle 114 and including the temperature-sensor 113 configured to sense the temperature of the moving airflow 20 as it passes through the liquid 118.

The temperature-regulator means 111 may be communicably coupled to the thermostat control-unit 134. Further, the temperature-regulator means 111 may also be communicably coupled to the forced air system 5. The temperature-regulator means 111 may be configured to regulate a temperature of the moving airflow 20 (via the processor) to ensure the twice-filtered air 129 passing into the at least one room 25 through the in-room air vent 30 matches the desired temperature on the thermostat control-unit 134 and depending on what mode the thermostat control-unit 134 is set to. As above, in some embodiments, the filter system 100 may include the liquid-swirling means 150 to move the liquid 118 and filter the moving airflow 20. Movement of the liquid 118 may further generate heat that may be directed into the at least one room 25, and may be used to ensure the twice-filtered air 129 matches the desired temperature.

In some embodiments, the temperature-regulator means 111 may be configured to signal the forced air system 5 to change a main temperature thereof. In some embodiments, the temperature-regulator means 111 may include a heating means therein (not illustrated). The heating means may be automatically turned on or off to match the desired temperature on the thermostat control-unit 134.

In other embodiments, dampers may be installed into the ductwork 15. The temperature-regulator means 111 may signal the dampers to direct or stop the moving airflow 20 into the at least one room 25 based on the desired temperature. Those with ordinary skill in the art will now appreciate that upon reading this specification and by their understanding the art of forced air systems as described herein, methods of air purifying and temperature control will be understood by those knowledgeable in such art.

As shown, the air vent cover 130 may include a plurality of shutters 132 that are selectively able to be opened and closed to control flow of the twice-filtered air 129 into the at least one room 25 (FIG. 1). Further, the air vent cover 130 may include a slider means 136 configured to selectively open and close the plurality of shutters 132. In some embodiments, the plurality of shutters 132 may be manually opened. In other embodiments, the plurality of shutters 132 may be automatically moved via an actuator means such as a motor (not illustrated).

In some embodiments, the plurality of shutters 132 may be in communication with the thermostat control-unit 134 and the temperature-regulator means 111. This may allow the temperature-regulator means 111 to maintain a room-temperature by selectively opening and closing the plurality of shutters 132 (via the processor) according to the desired temperature. Further, a power source 140 may be provided and configured to provide power to the filter system 100. In some embodiments, the power source 140 may be at least one battery 142. The at least one battery 142 may be removable or may be rechargeable. As shown, the at least one battery 142 may be located on the air vent cover 130. AC power may be used in certain embodiments.

It should be noted that, under appropriate circumstances, considering such issues as design preference, user preferences, marketing preferences, cost, structural requirements, available materials, technological advances, etc., other methods for filtering air and controlling air temperature are taught herein. Further, upon reading this specification, it should be appreciated that, under appropriate circumstances, considering such issues as user preferences, design preference, structural requirements, marketing preferences, cost, available materials, technological advances, etc., other filter arrangements and/or temperature control, sensing means such as may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A filter system for purifying air from a forced air system of a building, the forced air system utilizing ductwork installed within the building, the ductwork configured to deliver moving airflow from the forced air system to at least one room of the building via an in-room air vent, the filter system being configured for installation to the in-room air vent, the filter system comprising:
a first filter unit, the first filter unit including a first air inlet, a liquid receptacle and a first filtered air outlet, the liquid receptacle configured to store a liquid therein, the first filter unit configured to receive moving airflow via the first air inlet and filter the moving airflow via the liquid before it passes through the first filtered air outlet as once-filtered air;
a second filter unit connected to the first filter unit, the second filter unit including a second air inlet, a filtering means, and a second filtered air outlet, the second filter unit configured to receive the once-filtered air and filter the once-filtered air via the filtering means before it passes through the second filtered air outlet as twice-filtered air; and
an air vent cover, the air vent cover configured to fasten over the in-room air vent, the air vent cover including a plurality of shutters that are selectively able to be opened and closed to control flow of the twice-filtered air into the at least one room.

2. The filter system of claim 1, further comprising a thermostat control-unit attached to the air vent cover.

3. The filter system of claim 1, further comprising a liquid-swirling means attached about the liquid receptacle, the liquid-swirling means being configured to swirl the liquid in the liquid receptacle.

4. The filter system of claim 1, further comprising a temperature-regulator means attached about the liquid receptacle.

5. The filter system of claim 4, wherein the temperature-regulator means is communicably coupled to the thermostat control-unit.

6. The filter system of claim 5, wherein the temperature-regulator means includes a temperature-sensor.

7. The filter system of claim 6, wherein the temperature-sensor is configured to sense a temperature of the moving airflow.

8. The filter system of claim 6, wherein the temperature-regulator means further includes a water-level sensor.

9. The filter system of claim 1, further comprising a power source configured to provide power to the filter system.

10. The filter system of claim 1, wherein the filtering means includes a plurality of fibers.

11. The filter system of claim 10, wherein the second filter unit is a high-efficiency particulate air (HEPA) filter.

12. The filter system of claim 11, wherein the second filter unit is removable from the filter system.

13. The filter system of claim 1, wherein the first filter unit includes a receptacle-housing configured to house the liquid receptacle.

14. The filter system of claim 13, wherein the liquid receptacle is removable from the filter system.

15. The filter system of claim 1, wherein the air vent cover includes a slider means configured to selectively open and close the plurality of shutters.

16. A filter system for purifying air from a forced air system of a building, the forced air system utilizing ductwork installed within the building, the ductwork configured to deliver moving airflow from the forced air system to at least one room of the building via an in-room air vent, the system being configured for installation to the in-room air vent, the filter system comprising:
a first filter unit, the first filter unit including a first air inlet, a liquid receptacle and a first filtered air outlet, the liquid receptacle configured to store a liquid therein, the first filter unit configured to receive moving airflow via the air inlet and filter the moving airflow via the liquid before it passes through the first filtered air outlet as once-filtered air;
a temperature-regulator means attached about the liquid receptacle, the temperature-regulator means being communicably coupled to the forced air system, the temperature-regulator means further including a temperature-sensor configured to sense a temperature of the moving airflow;
a second filter unit connected to the first filter unit, the second filter unit including a second air inlet, a filtering means, and a second filtered air outlet, the second filter unit configured to receive the once-filtered air and filter the once-filtered air via the filtering means before it passes through the second filtered air outlet as twice-filtered air; and
an air vent cover, the air vent cover configured to fasten over the in-room air vent, the air vent cover including a plurality of shutters that are selectively able to be opened and closed to control flow of the twice-filtered air into the at least one room;
a thermostat control-unit attached to the air vent cover, the thermostat control-unit being communicably coupled to the temperature-regulator means; and
a power source configured to provide power to the filter system.

17. The filter system of claim 16, wherein the filtering means includes a plurality of fibers, wherein the second filter unit is a high-efficiency particulate air (HEPA) filter, and the second filter unit is removable from the filter system.

18. The filter system of claim 17, wherein the first filter unit includes a receptacle-housing configured to house the liquid receptacle, and wherein the liquid receptacle is removable from the filter system.

19. The filter system of claim 16, wherein the air vent cover includes a slider means configured to selectively open and close the plurality of shutters.

20. A filter system for purifying air from a forced air system of a building, the forced air system utilizing ductwork installed within the building, the ductwork configured to deliver moving airflow from the forced air system to at least one room of the building via an in-room air vent, the system being configured for installation to the in-room air vent, the filter system comprising:
a first filter unit, the first filter unit including a first air inlet, a liquid receptacle, a receptacle-housing configured to house the liquid receptacle and a first filtered air outlet, the liquid receptacle configured to store a liquid therein, the liquid receptacle being removable from the filter system, the first filter unit configured to receive moving airflow via the air inlet and filter the moving airflow via the liquid before it passes through the first filtered air outlet as once-filtered air;
a temperature-regulator means attached about the liquid receptacle, the temperature-regulator means being communicably coupled to the forced air system, the temperature-regulator means further including a temperature-sensor configured to sense a temperature of the moving airflow;
a second filter unit connected to the first filter unit, the second filter unit being removable from the filter system, the second filter unit being a high-efficiency particulate air (HEPA) filter, the second filter unit including a second air inlet, a filtering means, and a second filtered air outlet, the filtering means including a plurality of fibers, the second filter unit configured to receive the once-filtered air and filter the once-filtered air via the filtering means before it passes through the second filtered air outlet as twice-filtered air; and
an air vent cover, the air vent cover configured to fasten over the in-room air vent, the air vent cover including a plurality of shutters and a slider means configured to selectively manually open and close the plurality of shutters to control flow of the twice-filtered air into the at least one room;
a thermostat control-unit attached to the air vent cover, the thermostat control-unit being communicably coupled to the temperature-regulator means; and
a power source configured to provide power to the filter system.
